(19) United States
(12) Patent Application Publication
(10) Pub. No.: US 2003/0210190 A1
(43) Pub. Date: Nov. 13, 2003

(54) Dipole antenna structure

(76) Inventor: Yi-Chang Lai, Chungli City (TW)

Correspondence Address: SUPREME PATENT SERVICES, POST OFFICE BOX 2339, SARATOGA, CA, 95070, US

(21) Appl. No.: 10/139,929

(22) Filed: May 7, 2002

(51) Int. Cl. H01Q 1/24; H01Q 9/16

(52) U.S. Cl. 343/702; 343/793

(57) ABSTRACT

A dipole antenna includes a ground section and a radiation section spaced from each other and respectively connected to signal member and ground member of a coaxial cable. The radiation section includes first and second segments of different lengths which are positioned at different distances from the ground section for respectively receiving/transmitting radio frequency (RF) signals at different frequencies, such as 2.45 GHz and 5.25 GHz. A connection segment connects between the first and second segments and is substantially normal to the first and second segments. An edge of the first segment is connected to a corresponding edge of the ground section. The first and second segments are dimensioned and positioned to receive and transmit RF signals of different frequencies whereby the dipole antenna has a compact configuration that is operative at two frequencies.

### FIELD OF THE INVENTION

The present invention relates generally to a dipole antenna, and in particular to a dipole antenna structure operative to receive/transmit radio frequency (RF) signals at two different frequencies.

### BACKGROUND OF THE INVENTION

A dipole antenna comprises a ground section and a radiation section, which are respectively connected to ground member and signal member of a coaxial cable. The ground section has a surface area that is much greater than that of the radiation section. Such a large surface area makes it difficult to incorporate the dipole antenna in a compact hand-held communication device. This is because (1) the hand-held communication device has a very compact size and thus a very limited interior space and (2) the large surface area of the ground section of the dipole antenna interferes with mounting/dismounting other parts in the communication device.

An improved design of the dipole antenna is illustrated in FIG. 1 for reducing the size of the ground section of the dipole antenna. The conventional dipole antenna comprises a radiation section 41 and a ground section 42 connectable to a coaxial feed line 43. The ground section 42 is elongated with a small width. This reduces the surface area of the ground section 42. However, the conventional dipole antenna suffers the following disadvantages: (1) The conventional design is only operative in receiving/transmitting radio signal at a sole frequency as shown by the electrical characteristics illustrated in FIGS. 3 and 4 which show the electric characteristics of two conventional signal band antennae for electromagnetic signals at frequencies of 2.45 GHz and 5.25 GHz respectively. (2) To be operative at two different frequencies, two radiation sections are required to install the antennas inside a hand-held communication device. The inclusion of two radiation stations increase the amount of space required, and the cost.

Thus, it is desired to have a dipole antenna structure that is operative at two different frequencies without employing two separate antennas in order to overcome the problems discussed above.

### SUMMARY OF THE INVENTION

An object of the present invention is to provide a dipole antenna structure for operation at two different frequencies.

Another object of the present invention is to provide a dipole antenna structure having a simple, compact construction and thus cost effective but operative at two different frequencies.

To achieve the above objects, in accordance with the present invention, there is a dipole antenna comprising a ground section and a radiation section spaced from each other and respectively connected to signal member and ground member of a coaxial cable. The radiation section comprises the first and second segments of different lengths and positioned at different distances from the ground section for respectively receiving/transmitting radio frequency (RF) signals at different frequencies, such as 2.45 GHz and 5.25 GHz. A connection segment connects between the first and second segments and is substantially normal to the first and second segments. An edge of the first segment is connected to a corresponding edge of the ground section. The first and second segments are dimensioned and positioned to receive and transmit RF signals of different frequencies whereby the dipole antenna has a compact configuration that is operative at two frequencies.

### BRIEF DESCRIPTION OF THE DRAWINGS

The present invention will be apparent to those skills in the art by reading the following description of a preferred embodiment thereof, with reference to the attached drawings, in which:

FIG. 1 is a perspective view showing a conventional dipole antenna;

FIG. 2 is a perspective view of a dipole antenna constructed in accordance with the present invention;

FIGS. 3 and 4 are plots of electrical characteristics of conventional single band antennae;

FIG. 5 is a plot of electrical characteristics of the dipole antenna in accordance with the present invention;

FIG. 6 is a plot of voltage standing wave ratio (VSWR) of the dipole antenna in accordance with the present invention;

FIG. 7 is a plot of reflective loss of the dipole antenna in accordance with the present invention;

FIG. 8 is the E-plane radiation pattern of the dipole antenna of the present invention at 2.45 GHz frequency;

FIG. 9 is the H-plane radiation pattern of the dipole antenna of the present invention at 2.45 GHz frequency;

FIG. 10 is the E-plane radiation pattern of the dipole antenna of the present invention at 5.25 GHz; and

FIG. 11 is the H-plane radiation pattern of the dipole antenna of the present invention at 5.25 GHz.

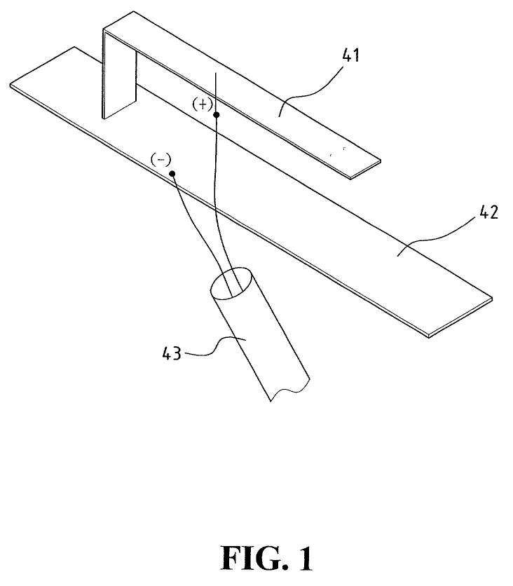

### DETAILED DESCRIPTION OF THE INVENTION

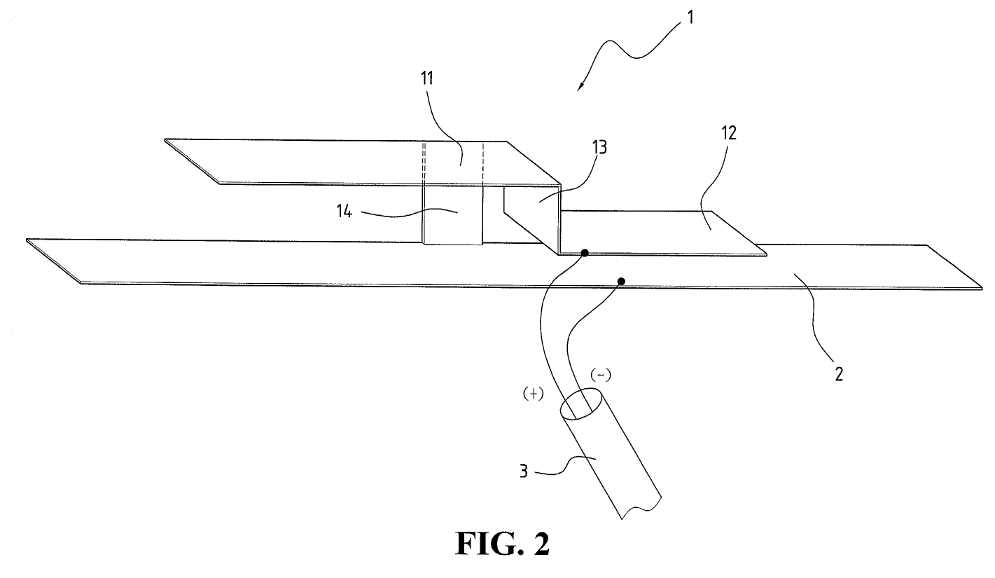

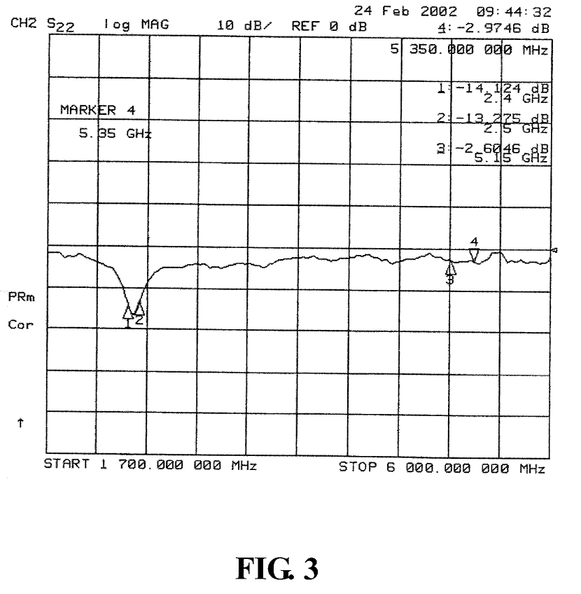

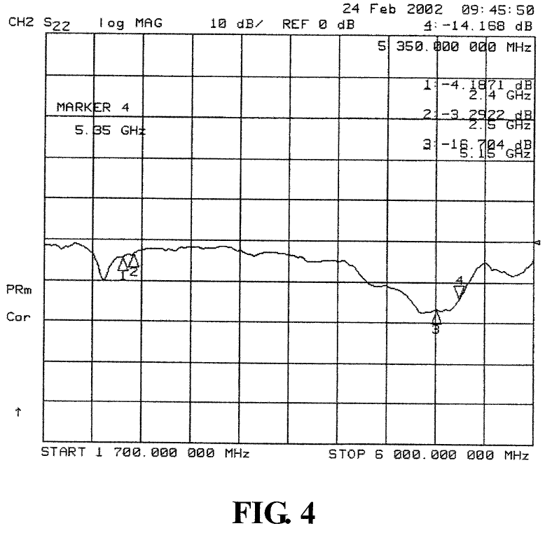

With reference to the drawings and in particular to FIG. 2, a dipole antenna constructed in accordance with the present invention comprises a ground section 2 and a radiation section 1 spaced from each other. The ground section 2 and the radiation section 1 are respectively connected to the ground member and signal line of a coaxial cable 3. The radiation section 1 comprises a first segment 11 and a second segment 12 that are offset with respect to and substantially parallel to each other. The first and second segments 11, 12 are substantially parallel to the ground section 2 and located at different distances from the ground section 2. A connection segment 13 connects the first and second segments 11, 12 together and is substantially normal to the first and second segments 11, 12. Thus, the radiation section 1 has a general shape of a “Z”.

The first and second segments 11, 12 have different lengths respectively corresponding to the wavelengths of two radio frequency (RF) signals for receiving/transmitting the signals of different frequencies. In the embodiment illustrated, the lengths of the first and second segments 11, 12 are selected to receive and transmit RF signals at 2.45 GHz and 5.25 GHz.

A support segment 14 is connected between lateral edges of the first segment 11 and the ground section 2.

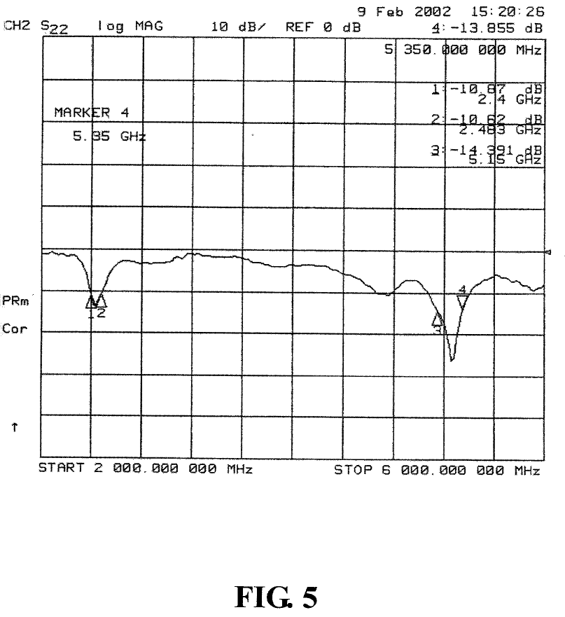

Also referring to FIG. 5, the electrical characteristics of the dipole antenna of the present invention is shown. The plot shown in FIG. 5 indicates that signals at frequencies of (1) 2.4-2.5 GHz and (2) 5.1-5.3 GHz can be effectively received and transmitted by the dipole antenna of the present invention.

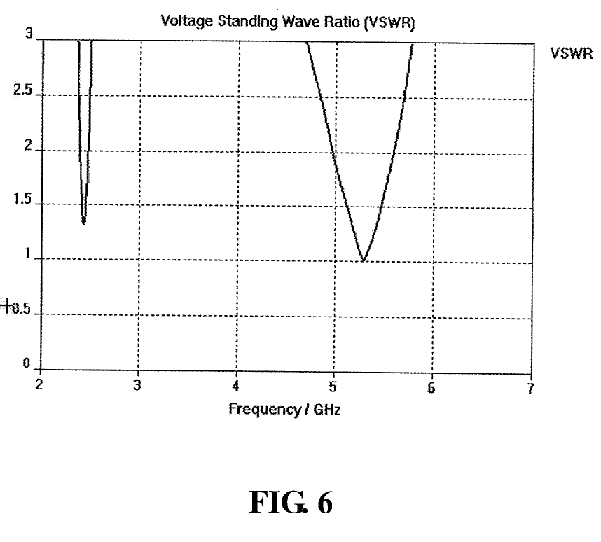

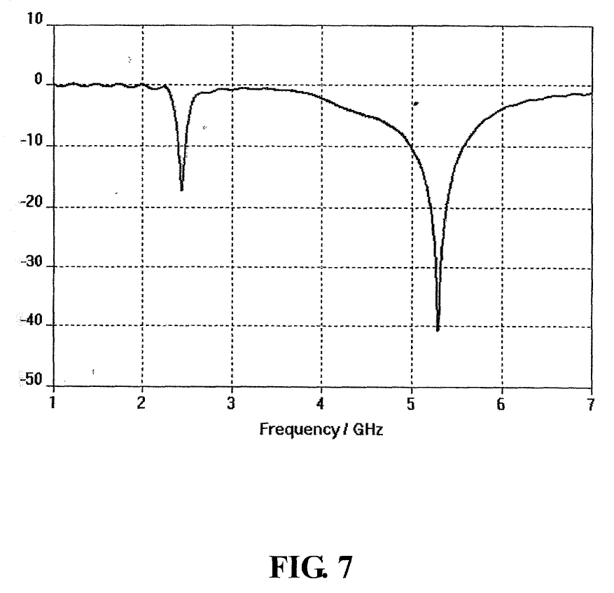

FIG. 6 shows the plot of the voltage standing wave ratio (VSWR) of the dipole antenna of the present invention. Similarly, the results show that signals at 2.45 GHz and 5.25 GHz can be effectively received and transmitted. FIG. 7 shows the plot of reflective loss of the dipole antenna of the present invention. In conclusion, the dipole antenna of the present invention is operative at frequencies of 2.45 GHz and 5.25 GHz can be made.

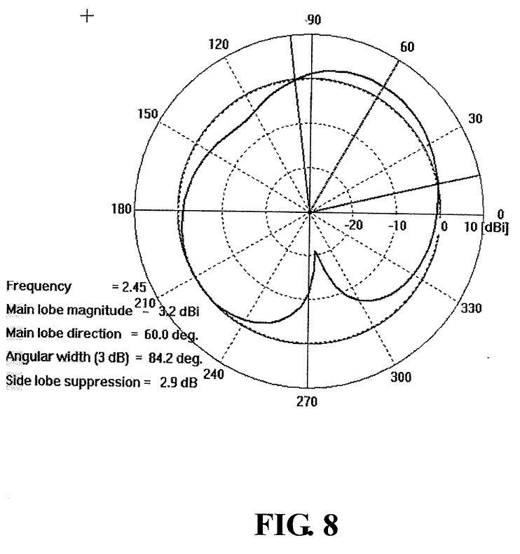

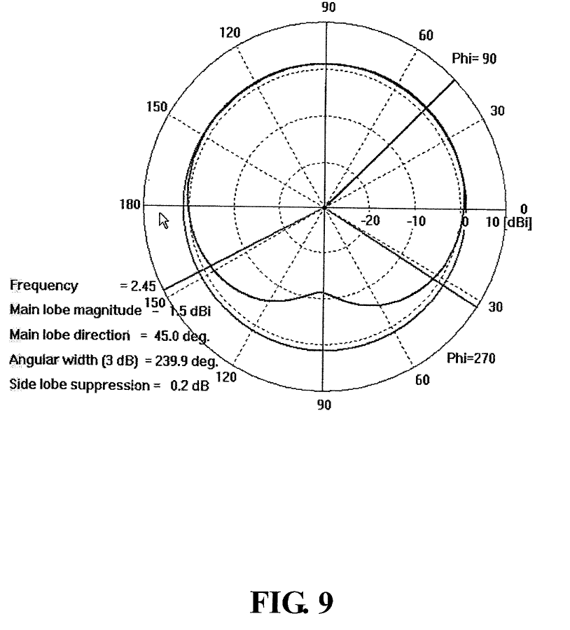

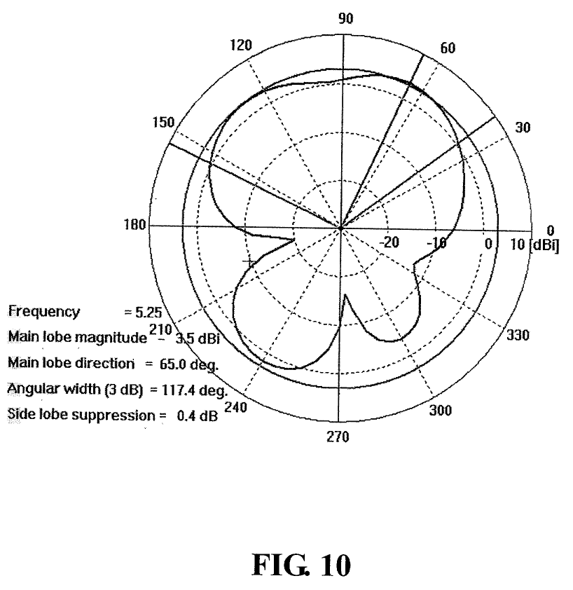

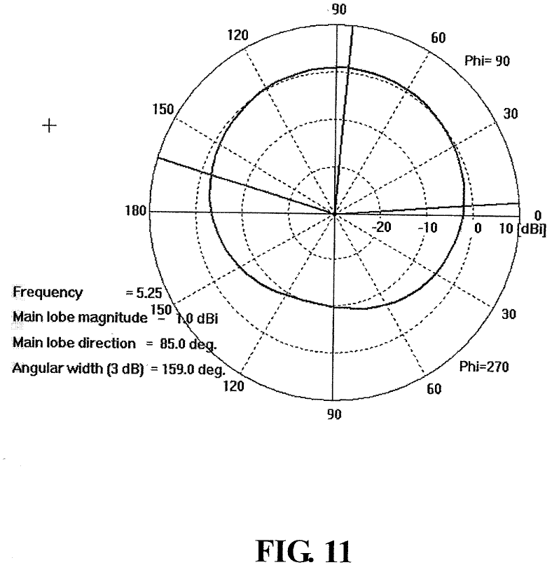

Radiation patterns in both E plane and H plane at frequency of 2.45 GHz are shown in FIGS. 8 and 9. A gain around 2.0 and 1.0 dBi can be found in the E plane and H plane radiation patterns for the dipole antenna of the present invention. Similarly, for gain at frequency of 5.25 GHz, the radiation patterns of E plane and H plane respectively shown in FIGS. 10 and 11 indicates that a 2.0 and 1.0 dBi gain can be obtained respectively for E plane and H plane radiation patterns.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A dipole antenna comprising a ground section and a radiation section spaced from each other and adapted to be respectively connected to signal member and ground member of a coaxial cable, the radiation section comprising first and second segments connected to each other, the first and second segments being substantially parallel to the ground section, an edge of the first segment being connected to a corresponding edge of the ground section.

2. The dipole antenna as claimed in claim 1, wherein the first segment has a first length, the second segment having a second length different from the first length.

3. The dipole antenna as claimed in claim 1, wherein the radiation section comprises a connection segment connected to both the first and second segments and substantially normal thereto.

4. The dipole antenna as claimed in claim 1, wherein the first and second segments of the radiation section are spaced from the ground section at different distances.

5. The dipole antenna as claimed in claim 1, wherein the first and second segments are dimensioned and arranged to receive and transmit signals at two different frequencies.

6. The dipole antenna as claimed in claim 5, wherein the two different frequencies are 2.45 GHz and 5.25 GHz.
